(19) United States
(12) Patent Application Publication
(10) Pub. No.: US 2014/0295014 A1
(43) Pub. Date: Oct. 2, 2014

(54) MOLD-TOOL SYSTEM HAVING STEM-GUIDANCE ASSEMBLY FOR GUIDING MOVEMENT OF VALVE-STEM ASSEMBLY

(71) Applicant: Husky Injection Molding Systems Ltd., Bolton (CA)

(72) Inventors: Domenico Favata, Konz (DE); Claude Francois Wolf, Kanfen (FR)

(73) Assignee: Husky Injection Molding Systems Ltd.

(21) Appl. No.: 14/356,671

(22) PCT Filed: Oct. 16, 2012
(86) PCT No.: PCT/CA2012/050726

§ 371 Date: May 7, 2014

Related U.S. Application Data
(60) Provisional application No. 61/557,009, filed on Nov. 8, 2011.

(51) Int. Cl. B29C 45/17

(52) U.S. Cl. CPC B29C 45/1781
USPC 425/150

(57) ABSTRACT

A mold-tool system (100), comprising: a body assembly (102); and a stem-guidance assembly (106) configured to maintain guiding movement of a valve-stem assembly (934) through the body assembly (102).

### TECHNICAL FIELD

Aspects generally relate to (and not limited to) mold-tool systems including (and not limited to) molding systems.

### BACKGROUND

U.S. Pat. No. 3,952,927 discloses a nozzle.

U.S. Pat. No. 5,505,613 discloses a mutual centering and sealing of a nozzle point and a mold insert.

U.S. Pat. No. 5,334,008 discloses an injection molding apparatus.

U.S. Pat. No. 6,159,000 discloses a hot runner valve gated injection molding device.

U.S. Pat. No. 7,513,772 discloses a valve-gated nozzle.

United States Patent Publication Number 2008031997 discloses an injector for injection molding of plastic materials.

### SUMMARY

The inventors have researched a problem associated with known molding systems that inadvertently manufacture bad-quality molded articles or parts. After much study, the inventors believe they have arrived at an understanding of the problem and its solution, which are stated below.

In a molding nozzle assembly, a valve stem assembly is not guided during part filling causing off center and shifting of the valve-stem assembly. This case may lead to uneven filling of the mold cavity and premature wear of a molding components, such as the nozzle assembly, nozzle tip, vespel insulator, valve stem assembly, and/or gate insert. In standard valve-gated molds, a stem-shadow effect exists that may cause uneven or a inhomogeneous melt flow through a nozzle tip into the mold cavity. It may also cause an uneven melt temperature distribution inside a nozzle tip that may cause an uneven filling of the part as well. Due to this situation, the melt properties around the molded parts are not even and may cause additional part quality issues later on. In case of bottling preforms and bottles, this may lead to uneven reheating of the preforms, stretching and blowing molding issues. Especially when using colorants and or additives, the stem shadow effect may cause uneven color distributions, uneven color homogeneity around the part and flow lines.

According to one aspect, there is provided a mold-tool system (100), comprising: a body assembly (102); and a stem-guidance assembly (106) configured to maintain guiding movement of a valve-stem assembly (934) through the body assembly (102).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

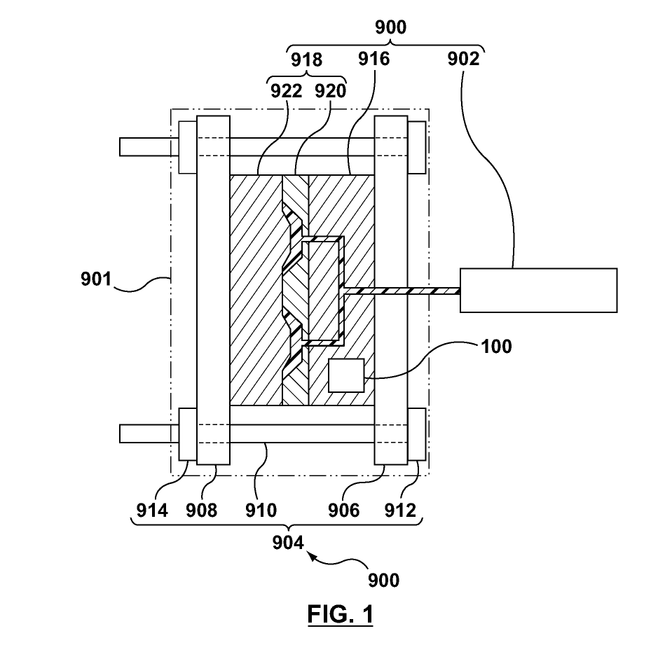

FIGS. 1, 2, 3, 4A, 4B, 5A, 5B, 6A, 6B, 7A, 7B depict example schematic representations of a mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted. DETAILED DESCRIPTION OF THE NON-LIMITING EMBODIMENT(S)

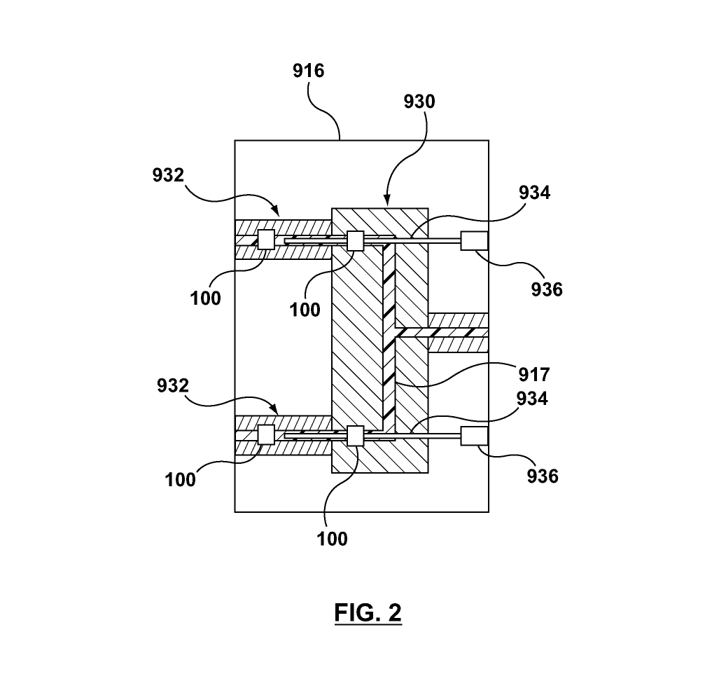

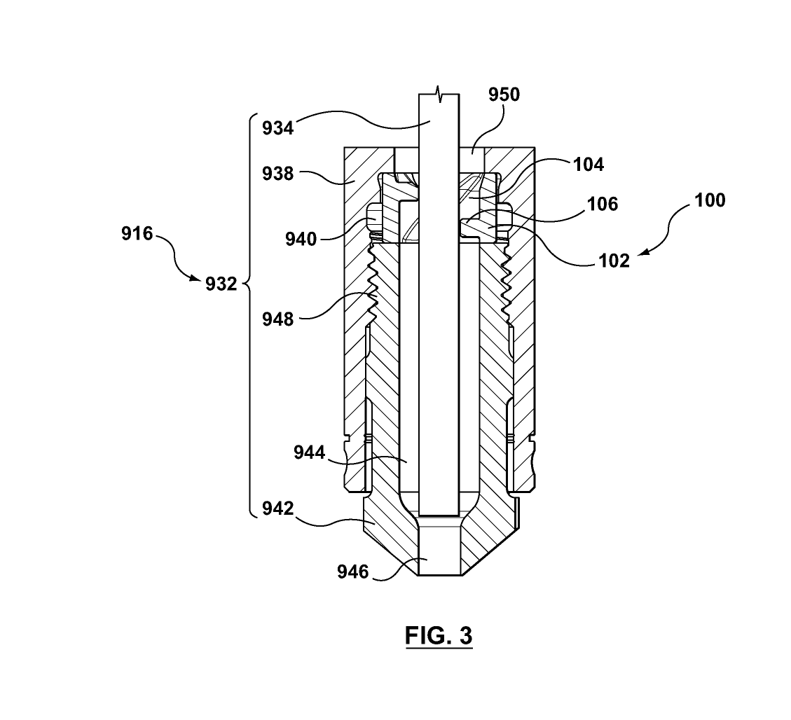

FIGS. 1, 2, 3, 4A, 4B, 5A, 5B, 6A, 6B, 7A, 7B depict the example schematic representations of the mold-tool system (100). It will be appreciated that the examples depicted in the FIGS. may be combined in any suitable permutation and combination. FIG. 1 depicts a molding system (900) having the mold-tool system (100). FIG. 1 depicts a runner system (916) having the mold-tool system (100). FIG. 2 depicts a manifold assembly (930) having the mold-tool system (100) FIGS. 2, 3 depict a nozzle assembly (932) having the mold-tool system (100). The molding system (900), the runner system (916), the manifold assembly (930), the nozzle assembly (932) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising.” The word “comprising” is a transitional phrase or word that links the preamble of a patent claim to the specific elements set forth in the claim that define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

Referring now to all of the FIGS, there is (generally speaking) depicted several examples of the schematic representations of the mold-tool system (100). The mold-tool system (100) includes (and not limited to): (i) a body assembly (102), and (ii) a stem-guidance assembly (106) configured to maintain guiding movement of a valve-stem assembly (934) through the body assembly (102). The stem-guidance assembly (106) may also be configured to rotate, at least in part, a melt around the valve-stem assembly (934) for a case where the melt is made to flow along the valve-stem assembly (934). The meaning of “configured to rotate” is to cause or to deflect the melt or the resin so that the deflected resin flows along, at least in part, a rotated path or a non parallel path, relative to the central axis that extends through the valve-stem assembly (934). Without the stem-guidance assembly (106), the resin would normally flow along a parallel direction relative to the central axis that extends through the valve-stem assembly (934). More specifically, the body assembly (102) defines a body passageway (104) extending through the body assembly (102). The body passageway (104) is configured to accommodate sliding movement of a valve-stem assembly (934). The stem-guidance assembly (106) extends from the body assembly (102) toward an interior of the body passageway (104). The stem-guidance assembly (106) is configured to maintain guiding movement of the valve-stem assembly (934) through the body passageway (104). Several advantages of the mold-tool system (100) include (and are not limited to): (1) the valve stem assembly may remain guided during the full injection molding filling and holding operation, (2) due to the stem shadow effect, the melt exiting a nozzle tip is not homogeneous, and by using the mold-tool system (100), the melt may be mixed or receives a mixing effect which may improve melt homogeneity and therefore a better part quality, (3) as the stem shadow effect is always in the opposite side of the melt entering location, rotating the melt may prevent melt stagnation, slow melt flow and therefore a better melt temperature distribution all around the stem and nozzle tip.

Referring now to FIG. 1, there is depicted an example of a schematic representation of the molding system (900) having the mold-tool system (100). The molding system (900) may also be called an injection-molding system for example. According to the example depicted in FIG. 1, the molding system (900) includes (and is not limited to): (i) an extruder assembly (902), (ii) a clamp assembly (904), (iii) a runner system (916), and/or (iv) a mold assembly (918). By way of example, the extruder assembly (902) is configured, to prepare, in use, a heated, flowable resin, and is also configured to inject or to move the resin from the extruder assembly (902) toward the runner system (916). Other names for the extruder assembly (902) may include injection unit, melt-preparation assembly, etc. By way of example, the clamp assembly (904) includes (and is not limited to): (i) a stationary platen (906), (ii) a movable platen (908), (iii) a rod assembly (910), (iv) a clamping assembly (912), and/or (v) a lock assembly (914). The stationary platen (906) does not move; that is, the stationary platen (906) may be fixedly positioned relative to the ground or floor. The movable platen (908) is configured to be movable relative to the stationary platen (906). A platen-moving mechanism (not depicted but known) is connected to the movable platen (908), and the platen-moving mechanism is configured to move, in use, the movable platen (908). The rod assembly (910) extends between the movable platen (908) and the stationary platen (906). The rod assembly (910) may have, by way of example, four rod structures positioned at the corners of the respective stationary platen (906) and the movable platen (908). The rod assembly (910) is configured to guide movement of the movable platen (908) relative to the stationary platen (906). A clamping assembly (912) is connected to the rod assembly (910). The stationary platen (906) supports the position of the clamping assembly (912). The lock assembly (914) is connected to the rod assembly (910), or may alternatively be connected to the movable platen (908). The lock assembly (914) is configured to selectively lock and unlock the rod assembly (910) relative to the movable platen (908). By way of example, the runner system (916) is attached to, or is supported by, the stationary platen (906). The runner system (916) includes (and is not limited to) a mold-tool system (100). The definition of the mold-tool system (100) is as follows: a system that may be positioned and/or may be used in a platen envelope (901) defined by, in part, an outer perimeter of the stationary platen (906) and the movable platen (908) of the molding system (900) (as depicted in FIG. 1). The molding system (900) may include (and is not limited to) the mold-tool system (100). The runner system (916) is configured to receive the resin from the extruder assembly (902). By way of example, the mold assembly (918) includes (and is not limited to): (i) a mold-cavity assembly (920), and (ii) a mold-core assembly (922) that is movable relative to the mold-cavity assembly (920). The mold-core assembly (922) is attached to or supported by the movable platen (908). The mold-cavity assembly (920) is attached to or supported by the runner system (916), so that the mold-core assembly (922) faces the mold-cavity assembly (920). The runner system (916) is configured to distribute the resin from the extruder assembly (902) to the mold assembly (918).

In operation, the movable platen (908) is moved toward the stationary platen (906) so that the mold-cavity assembly (920) is closed against the mold-core assembly (922), so that the mold assembly (918) may define a mold cavity configured to receive the resin from the runner system (916). The lock assembly (914) is engaged so as to lock the position of the movable platen (908) so that the movable platen (908) no longer moves relative to the stationary platen (906). The clamping assembly (912) is then engaged to apply a camping pressure, in use, to the rod assembly (910), so that the clamping pressure then may be transferred to the mold assembly (918). The extruder assembly (902) pushes or injects, in use, the resin to the runner system (916), which then the runner system (916) distributes the resin to the mold cavity structure defined by the mold assembly (918). Once the resin in the mold assembly (918) is solidified, the clamping assembly (912) is deactivated so as to remove the clamping force from the mold assembly (918), and then the lock assembly (914) is deactivated to permit movement of the movable platen (908) away from the stationary platen (906), and then a molded article may be removed from the mold assembly (918). It will be appreciated that the molding system (900) may have the mold-tool system (100), and that the runner system (916) may have the mold-tool system (100). On the other hand, the mold-tool system (100) may be sold separately from the molding system (900) and/or the runner system (916). For example, the mold-tool system (100) may be sold and supplied as a retrofit article to be installed on or in the molding system (900) and/or the runner system (916) that are already existing and used at manufacturing facilities configured to molding articles.

Referring now to FIG. 2, there is depicted an example of the schematic representation of the runner system (916). The runner system (916) includes (and is not limited to) a manifold assembly (930) has have the mold-tool system (100). The runner system (916) includes (and is not limited to) a nozzle assembly (932) has have the mold-tool system (100). It will be appreciated that the mold-tool system (100) may be sold separately from the manifold assembly (930) and/or the nozzle assembly (932). For example, the mold-tool system (100) may be sold and supplied as a retrofit article to be installed on or in the manifold assembly (930) and the nozzle assembly (932) that are already existing and used at manufacturing facilities configured for molding articles. The valve-stem assembly (934) is connected to a stem actuator (936). The stem actuator (936) is configured to actuatably move the valve-stem assembly (934) as known to those skilled in the art. The body assembly (102) is configured to be received in a melt-distribution channel (917) defined by the nozzle assembly (932) of the runner system (916).

Referring now to FIG. 3, there is depicted an example of the schematic representation of the nozzle assembly (932) having the mold-tool system (100). The body assembly (102) of the mold-tool system (100) is configured to rotate and to move the melt away from the stem shadow side of the valve-stem assembly (934). The body assembly (102) may also be further configured to mix the melt (or resin) for improved melt/resin homogeneity. As well, the body assembly (102) is configured to maintain central position of the valve-stem assembly (934) during operation of the valve-stem assembly (934). The body assembly (102) is also configured to rotate the melt (resin) from the stem shadow side, and is also configured to mix the melt with lowered pressure drop to the melt. Some additional advantages are (and not limited to): (1) reduce wear to various components such as nozzle tip, stem, gate insert, (2) improve quality of the preform gate nub (which is an aspect of the molded article), (3) reduce tearing of the resin at the mold gate, (4) reduce appearance of melt flow lines having colorants and/or other additives in the resin due to the shadow side of the valve-stem assembly (934), (5) improve balancing of the runner system (916), (6) improve injection of multilayer resin in regard to uneven barrier material melt front, (7) improve preform support ledge short as the issue appears at the stem shadow side, (8) improve quality of the blown bottle due to improved quality to the preform (especially due to a more homogeneous melt or resin), (9) improve speed of color changes in the melt.

The nozzle assembly (932) includes (and is not limited to): a nozzle-body assembly (938) having a nozzle outlet (946) and a nozzle inlet (950). The nozzle-body assembly (938) defines a nozzle-body passage (940) extending from the nozzle outlet (946) to the nozzle inlet (950). The nozzle-body passage (940) is configured to receive and to accommodate sliding movement of the valve-stem assembly (934). The nozzle inlet (950) is configured to accommodate sliding movement of the valve-stem assembly (934). The nozzle outlet (946) is configured to be closed and opened by the valve-stem assembly (934). The body assembly (102) is received in the nozzle-body passage (940). The body assembly (102) abuts the nozzle-body assembly (938) at the nozzle inlet (950).

According to an option, the nozzle assembly (932) may further include (and is not limited to): a tip assembly (942) received in the nozzle-body passage (940). The tip assembly (942) defines a tip passage (944). The tip assembly (942) is connected to the nozzle-body assembly (938) by way of threads (948) for example. The tip passage (944) is configured to receive (and to accommodate slide movement of) the valve-stem assembly (934). The body assembly (102) is positioned between the tip assembly (942) and the nozzle-body assembly (938). The body assembly (102) abuts the tip assembly (942) and the nozzle-body assembly (938). It will be appreciated that generally speaking the nozzle assembly (932) is configured to support positioning of the body assembly (102) as may be required for any particular type of nozzle assembly.

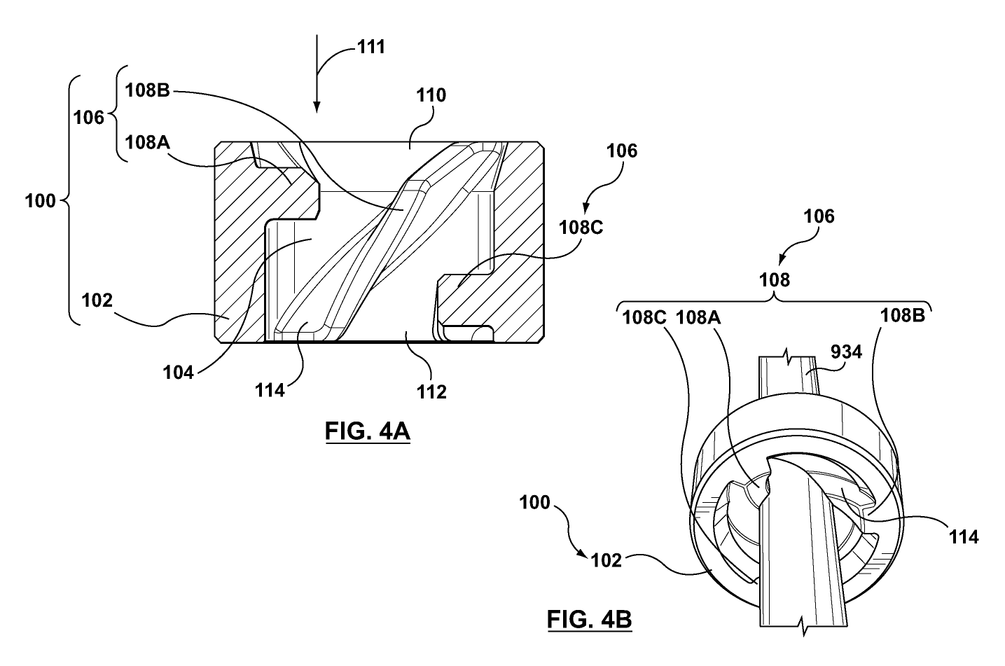

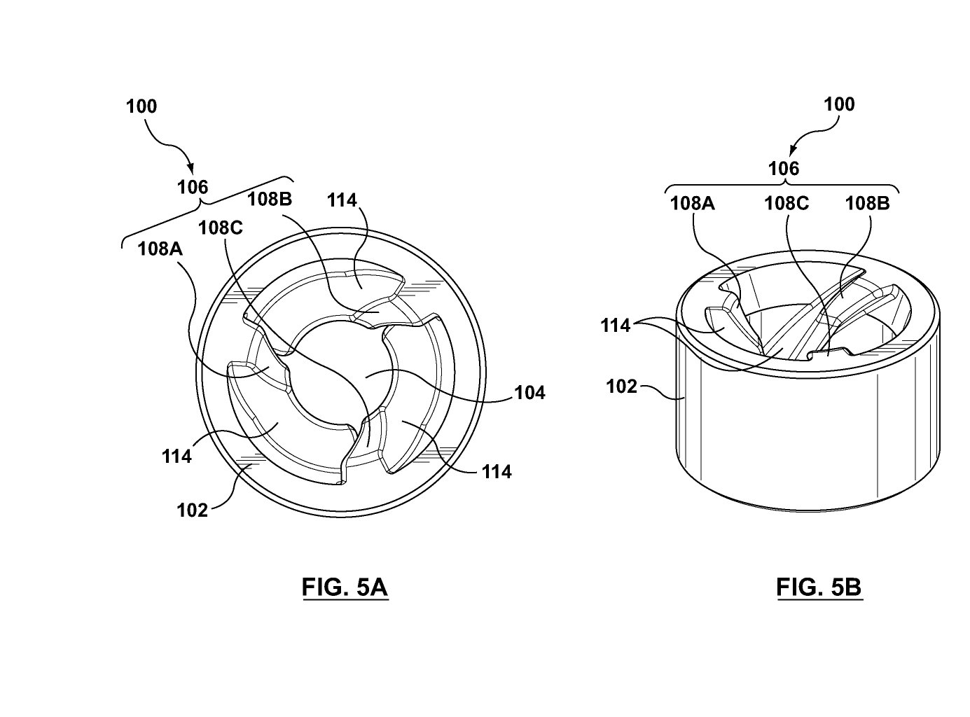

Referring now to FIGS. 4A, 4B, 5A, 5B, there is depicted an example of the schematic representations of the body assembly (102) of the mold-tool system (100). Specifically, FIG. 4A depicts a cross section of the body assembly (102). FIG. 4B depicts a perspective view of the body assembly (102). FIG. 5A depicts a top view of the body assembly (102). FIG. 5B depicts side perspective view of the body assembly (102). The body assembly (102) defines a body passageway (104) extending through the body assembly (102). The body passageway (104) is configured to accommodate sliding movement of a valve-stem assembly (934). The stem-guidance assembly (106) extends from the body assembly (102) toward an interior of the body passageway (104). The stem-guidance assembly (106) is configured to support and to maintain guiding (sliding) movement of the valve-stem assembly (934) through the body passageway (104). The body assembly (102) includes a melt entrance (110) and a melt exit (112). The body passageway (104) extends from the melt entrance (110) to the melt exit (112). The stem-guidance assembly (106) is configured to be in sliding contact with the valve-stem assembly (934). That is, the stem-guidance assembly (106) contacts the valve-stem assembly (934) but permits slide movement of the valve-stem assembly (934). The meaning of “sliding contact” may include a tight fit or a loose fit, within an acceptable level of tolerance. If less friction is required, then loose contact may be used. The stem-guidance assembly (106) may be pre-guiding, which means that it provides a loose fit to pre-guide the valve-stem assembly (934).

According to an option, the stem-guidance assembly (106) includes (and is not limited to) a grouping of stem-guide elements (108) extending from the body assembly (102) toward the interior of the body passageway (104). Each member of the grouping of stem-guide elements (108) is configured to be in sliding contact with the valve-stem assembly (934). Each member of the grouping of stem-guide elements (108) includes a melt rotation surface (114) is configured to face the melt entrance (110) of the body assembly (102). The melt rotation surface (114) is configured to rotate, at least in part, the melt around the valve-stem assembly (934) for a case where the melt is made to flow along the valve-stem assembly (934). The melt, in use, flows along a melt flow direction (111). According to an option, the members of the grouping of stem-guide elements (108) are positioned symmetrically equidistant from each other, so that the flow of the melt (resin) through the body passageway (104) is evenly distributed (as much as possible) through the body assembly (102). The melt rotation surface (114) may be a curved that is inclined relative to the central axis that extends (at least in part) through the body assembly (102) from melt entrance (110) to the melt exit (112). The melt rotation surface (114) may be: (i) a curvilinear shaped surface (as depicted), or (ii) a rectilinear shaped surface (not depicted).

By way of example, the grouping of stem-guide elements (108) includes (and is not limited to): a first stem-guide element (108A), a second stem-guide element (108A) and a third stem-guide element (108A). The first stem-guide element (108A), the second stem-guide element (108A) and the third stem-guide element (108A) are positioned symmetrically equidistant from each other. According to another option, each member of the grouping of stem-guide elements (108) is positioned symmetrically equidistant from each other.

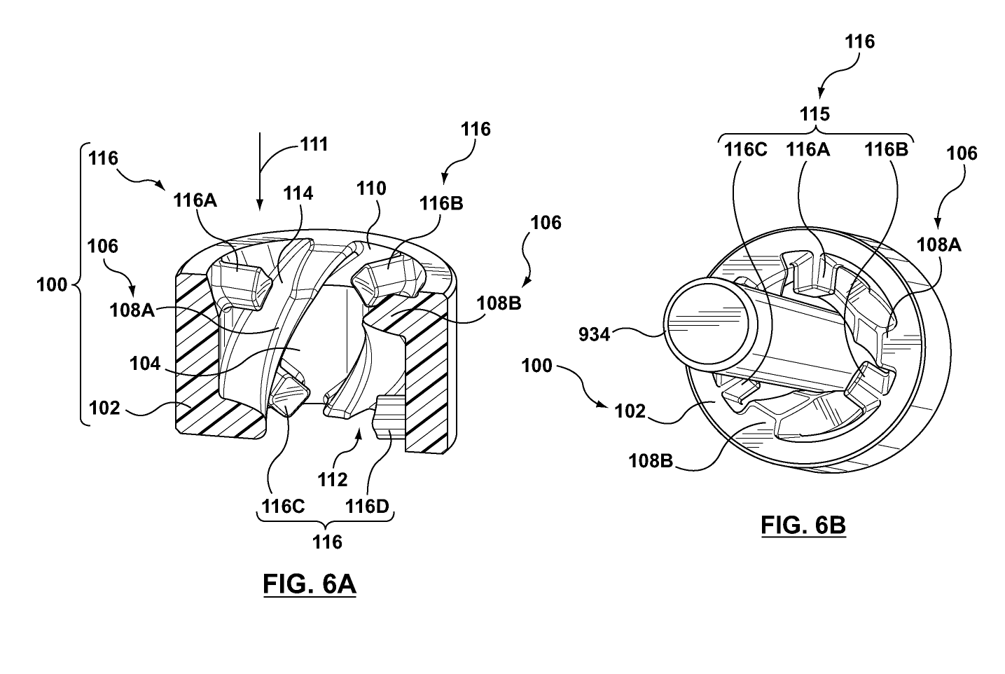

Referring now to FIGS. 6A, 6B, the melt-mixing assembly (116) includes (and is not limited to): a first melt-mixing element (116A), a second melt-mixing element (116B), and a third melt-mixing element (116C). The first melt-mixing element (116A), the second melt-mixing element (116B), and the third melt-mixing element (116C) are positioned symmetrically equidistant from each other. The members of the set of melt-mixing elements (115) may all have the same shape or several members may have different shapes.

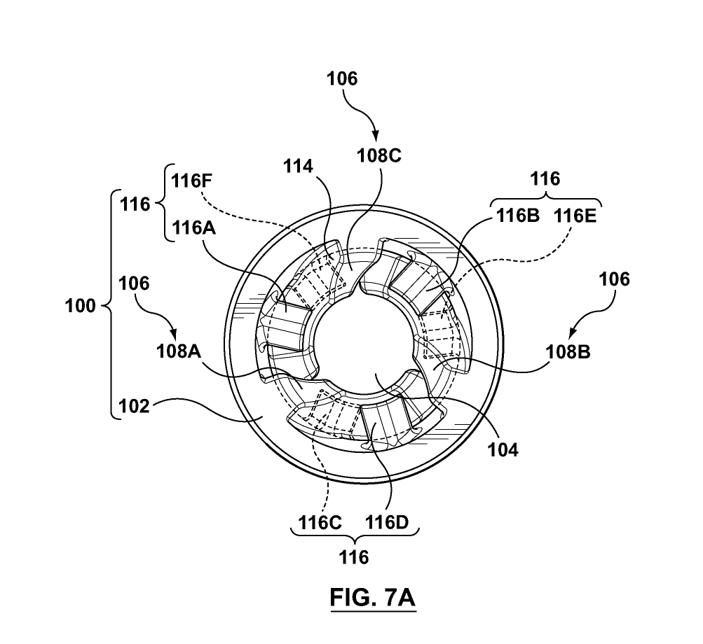

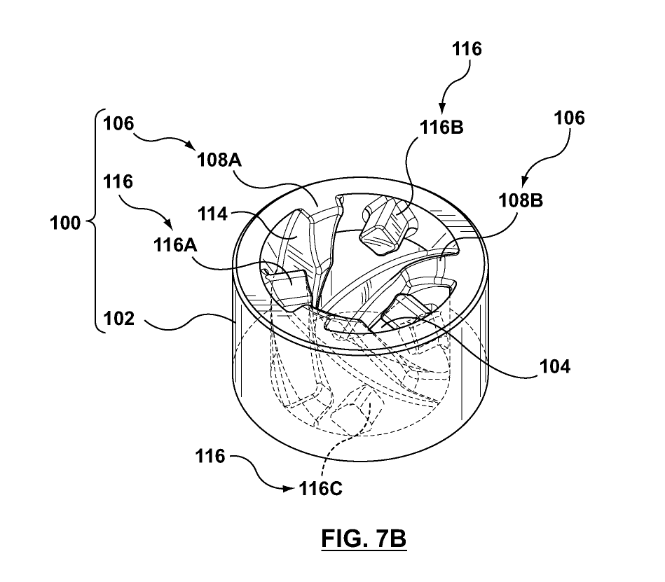

Referring now to FIGS. 6A, 6B, 7A, 7B, there is depicted another example of the schematic representations of the body assembly (102) of the mold-tool system (100). Specifically, FIG. 6A depicts a cross-sectional, perspective view of the body assembly (102). FIG. 6B depicts a perspective view of the body assembly (102). FIG. 7A depicts a top view of the body assembly (102). FIG. 7B depicts a perspective side view of the body assembly (102). The melt-mixing assembly (116) extends from the body assembly (102) toward the interior of the body passageway (104). According to an option, the item (116) does not contact the valve-stem assembly (934). But on the other hand according to another option (not depicted), the item (116) may contact the valve-stem assembly (934). The melt-mixing assembly (116) is configured to mix, at least in part, the melt (resin) positioned within the interior of the body passageway (104).

According to an option (as depicted), (i) the melt-mixing assembly (116) includes (and is not limited to) a set of melt-mixing elements (115) extending from the body assembly (102) toward the interior of the body passageway (104), and (ii) the stem-guidance assembly (106) includes (and is not limited to) a grouping of stem-guide elements (108) extending from the body assembly (102) toward the interior of the body passageway (104). The members of the set of melt-mixing elements (115) and the members of the grouping of stem-guide elements (108) interlace each other while permitting flow of the melt through the body assembly (102).

According to an option, the members of the set of melt-mixing elements (115) and the members of the grouping of stem-guide elements (108) are symmetrically positioned relative to each other.

According to another option, the each member of the set of melt-mixing elements (115) is positioned symmetrically equidistant from each other, regardless of the specific shape of orientation of the stem-guidance assembly (106).

According to one option, all the members of the set of melt-mixing elements (115) are post-shaped elements having square-shaped cross section, of which has four apex portions (or pointed portions), of which one of the apex portions that faces the melt entrance (110), another apex portion faces the melt exit (112), while the other opposite apex portions extends side to side to form side sloping surfaces that causes the resin to deflect away from the post-shaped elements, thus causing the resin to mix, at least in part, in the body assembly (102).

Referring now to FIGS. 7A, 7B, the melt-mixing assembly (116) includes (and is not limited to): a first melt-mixing element (116A), a second melt-mixing element (116B), a third melt-mixing element (116C), a fourth melt-mixing element (116D), a fifth melt-mixing element (116E), and a sixth melt-mixing element (116F). The first melt-mixing element (116A), the second melt-mixing element (116B), the third melt-mixing element (116C), the fourth melt-mixing element (116D), the fifth melt-mixing element (116E), and the sixth melt-mixing element (116F) are positioned symmetrically equidistant from each other.

ADDITIONAL DESCRIPTION

The following clauses are offered as further description of the examples of the mold-tool system (100): Clause (1): a mold-tool system (100), comprising: a body assembly (102); and stem-guidance assembly (106) configured to maintain guiding movement of a valve-stem assembly (934) through the body assembly (102). Clause (2): the mold-tool system (100) of any clause mentioned in this paragraph, wherein: the stem-guidance assembly (106) also is configured to rotate, at least in part, a melt around the valve-stem assembly (934) for a case where the melt is made to flow along the valve-stem assembly (934). Clause (3): the mold-tool system (100) of any clause mentioned in this paragraph, wherein: the body assembly (102) defines a body passageway (104) extending through the body assembly (102), the body passageway (104) is configured to accommodate sliding movement of a valve-stem assembly (934); and the stem-guidance assembly (106) extends from the body assembly (102) toward an interior of the body passageway (104), the stem-guidance assembly (106) is configured to maintain guiding movement of the valve-stem assembly (934) through the body passageway (104). Clause (4): the mold-tool system (100) of any clause mentioned in this paragraph, wherein: the body assembly (102) is configured to be received in a melt-distribution channel (917) being defined by a nozzle assembly (932) of a runner system (916), the nozzle assembly (932) includes: a nozzle-body assembly (938) having a nozzle outlet (946) and a nozzle inlet (950), the nozzle-body assembly (938) defining a nozzle-body passage (940) extending from the nozzle outlet (946) to the nozzle inlet (950), the nozzle-body passage (940) is configured to receive and to accommodate sliding movement of the valve-stem assembly (934). The nozzle inlet (950) is configured to accommodate sliding movement of the valve-stem assembly (934). The nozzle outlet (946) is configured to be closed and opened by the valve-stem assembly (934). The body assembly (102) is received in the nozzle-body passage (940), and the body assembly (102) abuts the nozzle-body assembly (938) at the nozzle inlet (950). Clause (5): the mold-tool system (100) of claim 3, wherein: the nozzle assembly (932) further includes: a tip assembly (942) received in the nozzle-body passage (940), the tip assembly (942) defining a tip passage (944). The tip assembly (942) is connected to the nozzle-body assembly (938). The tip passage (944) is configured to receive the valve-stem assembly (934), and the body assembly (102) is positioned between the tip assembly (942) and the nozzle-body assembly (938), and the body assembly (102) abuts the tip assembly (942) and the nozzle-body assembly (938). Clause (6): the mold-tool system (100) of any clause mentioned in this paragraph, wherein: the stem-guidance assembly (106) is configured to be in sliding contact with the valve-stem assembly (934). Clause (7): the mold-tool system (100) of any clause mentioned in this paragraph, wherein: the stem-guidance assembly (106) includes a grouping of stem-guide elements (108) extending from the body assembly (102) toward the interior of the body passageway (104). Clause (8): the mold-tool system (100) of any clause mentioned in this paragraph, wherein: the stem-guidance assembly (106) includes a grouping of stem-guide elements (108) extending from the body assembly (102) toward the interior of the body passageway (104), and the grouping of stem-guide elements (108) is configured to be in sliding contact with the valve-stem assembly (934). Clause (9): the mold-tool system (100) of any clause mentioned in this paragraph, wherein: the stem-guidance assembly (106) includes a grouping of stem-guide elements (108) extending from the body assembly (102) toward the interior of the body passageway (104). Each member of the grouping of stem-guide elements (108) includes a melt rotation surface (114) configured to face a melt entrance (110) of the body assembly (102), and the melt rotation surface (114) is configured to rotate, at least in part, the melt around the valve-stem assembly (934) for a case where the melt is made to flow along the valve-stem assembly (934). Clause (10): the mold-tool system (100) of any clause mentioned in this paragraph, wherein: the stem-guidance assembly (106) includes a grouping of stem-guide elements (108) extending from the body assembly (102) toward the interior of the body passageway (104), and the grouping of stem-guide elements (108) are positioned symmetrically equidistant from each other. Clause (11); the mold-tool system (100) of any clause mentioned in this paragraph, wherein: the stem-guidance assembly (106) includes a grouping of stem-guide elements (108) extending from the body assembly (102) toward the interior of the body passageway (104), and the grouping of stem-guide elements (108), each member of the grouping of stem-guide elements (108) are positioned symmetrically equidistant from each other. Clause (12); the mold-tool system (100) of any clause mentioned in this paragraph, further comprising: a melt-mixing assembly (116) extending from the body assembly (102) toward the interior of the body passageway (104). The melt-mixing assembly (116) is configured to mix, at least in part, a melt positioned within the interior of the body passageway (104). Clause (13): the mold-tool system (100) of any clause mentioned in this paragraph, further comprising: a melt-mixing assembly (116) extending from the body assembly (102) toward the interior of the body passageway (104), the melt-mixing assembly (116) configured to mix, at least in part, a melt positioned within the interior of the body passageway (104), the melt-mixing assembly (116) includes: a set of melt-mixing elements (115) extending from the body assembly (102) toward the interior of the body passageway (104), the stem-guidance assembly (106) includes a grouping of stem-guide elements (108) extending from the body assembly (102) toward the interior of the body passageway (104), and the set of melt-mixing elements (115) and the grouping of stem-guide elements (108) interlacing each other. Clause (14): the mold-tool system (100) of any clause mentioned in this paragraph, further comprising: a melt-mixing assembly (116) extending from the body assembly (102) toward the interior of the body passageway (104), the melt-mixing assembly (116) configured to mix, at least in part, a melt positioned within the interior of the body passageway (104), the melt-mixing assembly (116) includes: a set of melt-mixing elements (115) extending from the body assembly (102) toward the interior of the body passageway (104), the stem-guidance assembly (106) includes a grouping of stem-guide elements (108) extending from the body assembly (102) toward the interior of the body passageway (104), and the set of melt-mixing elements (115) and the grouping of stem-guide elements (108) that are symmetrically positioned relative to each other.

It will be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system (100), comprising:
a body assembly (102); and
stem-guidance assembly (106) configured to maintain guiding movement of a valve-stem assembly (934) through the body assembly (102)

2. The mold-tool system (100) of claim 1, wherein:
the stem-guidance assembly (106) also being configured to rotate, at least in part, a melt around the valve-stem assembly (934) for a case where the melt is made to flow along the valve-stem assembly (934).

3. The mold-tool system (100) of any preceding claim, wherein:
the body assembly (102) defines a body passageway (104) extending through the body assembly (102), the body passageway (104) is configured to accommodate sliding movement of a valve-stem assembly (934); and
the stem-guidance assembly (106) extends from the body assembly (102) toward an interior of the body passageway (104), the stem-guidance assembly (106) being configured to maintain guiding movement of the valve-stem assembly (934) through the body passageway (104).

4. The mold-tool system (100) of any preceding claim, wherein:
the body assembly (102) is configured to be received in a melt-distribution channel (917) being defined by a nozzle assembly (932) of a runner system (916),
the nozzle assembly (932) includes:
a nozzle-body assembly (938) having a nozzle outlet (946) and a nozzle inlet (950), the nozzle-body assembly (938) defining a nozzle-body passage (940) extending from the nozzle outlet (946) to the nozzle inlet (950), the nozzle-body passage (940) is configured to receive and to accommodate sliding movement of the valve-stem assembly (934),
the nozzle inlet (950) being configured to accommodate sliding movement of the valve-stem assembly (934),
the nozzle outlet (946) being configured to be closed and opened by the valve-stem assembly (934), and
the body assembly (102) is received in the nozzle-body passage (940), and the body assembly (102) abuts the nozzle-body assembly (938) at the nozzle inlet (950).

5. The mold-tool system (100) of claim 3, wherein:
the nozzle assembly (932) further includes:
a tip assembly (942) received in the nozzle-body passage (940), the tip assembly (942) defining a tip passage (944), the tip assembly (942) being connected to the nozzle-body assembly (938), the tip passage (944) being configured to receive the valve-stem assembly (934), and
the body assembly (102) is positioned between the tip assembly (942) and the nozzle-body assembly (938), and the body assembly (102) abuts the tip assembly (942) and the nozzle-body assembly (938).

6. The mold-tool system (100) of any preceding claim, wherein:
the stem-guidance assembly (106) is configured to be in sliding contact with the valve-stem assembly (934).

7. The mold-tool system (100) of any preceding claim, wherein:
the stem-guidance assembly (106) includes a grouping of stem-guide elements (108) extending from the body assembly (102) toward the interior of the body passageway (104).

8. The mold-tool system (100) of any preceding claim, wherein:
the stem-guidance assembly (106) includes a grouping of stem-guide elements (108) extending from the body assembly (102) toward the interior of the body passageway (104), and
the grouping of stem-guide elements (108) is configured to be in sliding contact with the valve-stem assembly (934).

9. The mold-tool system (100) of any preceding claim, wherein:
the stem-guidance assembly (106) includes a grouping of stem-guide elements (108) extending from the body assembly (102) toward the interior of the body passageway (104), and
each member of the grouping of stem-guide elements (108) includes a melt rotation surface (114) being configured to face a melt entrance (110) of the body assembly (102), and
the melt rotation surface (114) is configured to rotate, at least in part, the melt around the valve-stem assembly (934) for a case where the melt is made to flow along the valve-stem assembly (934).

10. The mold-tool system (100) of any preceding claim, wherein:
the stem-guidance assembly (106) includes a grouping of stem-guide elements (108) extending from the body assembly (102) toward the interior of the body passageway (104), and
the grouping of stem-guide elements (108) are positioned symmetrically equidistant from each other.

11. The mold-tool system (100) of any preceding claim, wherein:
the stem-guidance assembly (106) includes a grouping of stem-guide elements (108) extending from the body assembly (102) toward the interior of the body passageway (104), and
the grouping of stem-guide elements (108), each member of the grouping of stem-guide elements (108) are positioned symmetrically equidistant from each other.

12. The mold-tool system (100) of any preceding claim, further comprising:
a melt-mixing assembly (116) extending from the body assembly (102) toward the interior of the body passageway (104), the melt-mixing assembly (116) being configured to mix, at least in part, a melt being positioned within the interior of the body passageway (104).

13. The mold-tool system (100) of any preceding claim, further comprising:
a melt-mixing assembly (116) extending from the body assembly (102) toward the interior of the body passageway (104), the melt-mixing assembly (116) being configured to mix, at least in part, a melt being positioned within the interior of the body passageway (104), the melt-mixing assembly (116) includes:
a set of melt-mixing elements (115) extending from the body assembly (102) toward the interior of the body passageway (104),
the stem-guidance assembly (106) includes a grouping of stem-guide elements (108) extending from the body assembly (102) toward the interior of the body passageway (104), and
the set of melt-mixing elements (115) and the grouping of stem-guide elements (108) interlacing each other.

14. The mold-tool system (100) of any preceding claim, further comprising:
a melt-mixing assembly (116) extending from the body assembly (102) toward the interior of the body passageway (104), the melt-mixing assembly (116) being configured to mix, at least in part, a melt being positioned within the interior of the body passageway (104), the melt-mixing assembly (116) includes:
a set of melt-mixing elements (115) extending from the body assembly (102) toward the interior of the body passageway (104),
the stem-guidance assembly (106) includes a grouping of stem-guide elements (108) extending from the body assembly (102) toward the interior of the body passageway (104), and
the set of melt-mixing elements (115) and the grouping of stem-guide elements (108) being symmetrically positioned relative to each other.

15. A molding system (900) having the mold-tool system (100) of any preceding claim.

16. A runner system (916) having the mold-tool system (100) of any preceding claim.

17. A manifold assembly (930) having the mold-tool system (100) of any preceding claim.

18. A nozzle assembly (932) having the mold-tool system (100) of any preceding claim.
